(19) United States
(12) Patent Application Publication
(10) Pub. No.: US 2011/0087544 A1
(43) Pub. Date: Apr. 14, 2011

(54) OPTIMIZATION OF AD SELECTION AND/OR PLACEMENT IN MEDIA OBJECTS

(75) Inventor: Zachary Mason, Palo Alto, CA (US)

(73) Assignee: EFFICIENT FRONTIER, Sunnyvale, CA (US)

(21) Appl. No.: 12/970,697

(22) Filed: Dec. 16, 2010

Related U.S. Application Data
(63) Continuation of application No. 11/689,005, filed on Mar. 21, 2007.
(60) Provisional application No. 60/784,293, filed on Mar. 21, 2006.

(51) Int. Cl. G06Q 30/00

(52) U.S. Cl. 705/14.49

(57) ABSTRACT

Methods, apparatuses, and articles of manufacture for determining optimal selection and/or placement of advertisements in various media objects, based on features of the advertisements and media objects, are described herein.

### RELATED APPLICATIONS

The present application is a continuation of U.S. patent application Ser. No. 11/689,005, entitled “Optimization of Ad Selection and/or Placement in Media Objects” and was filed Mar. 21, 2007, which itself claims the benefit of U.S. Provisional Patent Application 60/784,293, entitled “Optimization of Ad Placement in Various Media” and was filed on Mar. 21, 2006. The specifications of the 11/689,005 nonprovisional application and the 60/784,293 provisional application are hereby fully incorporated by reference.

### FIELD

The present invention relates generally to data processing. More specifically, the present invention relates to determining optimal placement of advertisements in various media objects.

### BACKGROUND

Advancements in media content such as television programs, radio programs, and other types of visual and/or audio content have given rise to increased opportunities for advertisers to have their ads placed in a variety of media objects, sometimes in a variety of locations within the same object. Media objects, however, have a duration, and may have multiple topics or may present material relevant to multiple topics that may be discussed at various times throughout the duration. Selecting an optimal advertisement for a specific time in a media object's duration without having someone view or listen to the media object may be problematic, especially in the context of digitally recorded media where media objects are stored on the Internet or on a storage device such as TiVo.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 is a flow chart depicting various embodiments of the invention for placing and/or selecting advertisements for media objects; and

FIG. 3 illustrates an exemplary computing device capable of performing the operations of various embodiments of the present invention.

### DETAILED DESCRIPTION

Illustrative embodiments of the present invention include but are not limited to methods and apparatuses for reading, by a computer system a description describing one or more features of a media object. In various embodiments, the computer system may place an advertisement into a location within the media object based at least in part on the one or more features of the media object. In other embodiments, the computer system may generate one or more derivative features for the media object based at least in part on the one or more features of the media object and select one or more advertisements to be placed in the media object based at least in part on the generated one or more derivative features of the media object.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The term “instant”, as used herein, includes both indivisible instants of time and time intervals of varying durations.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

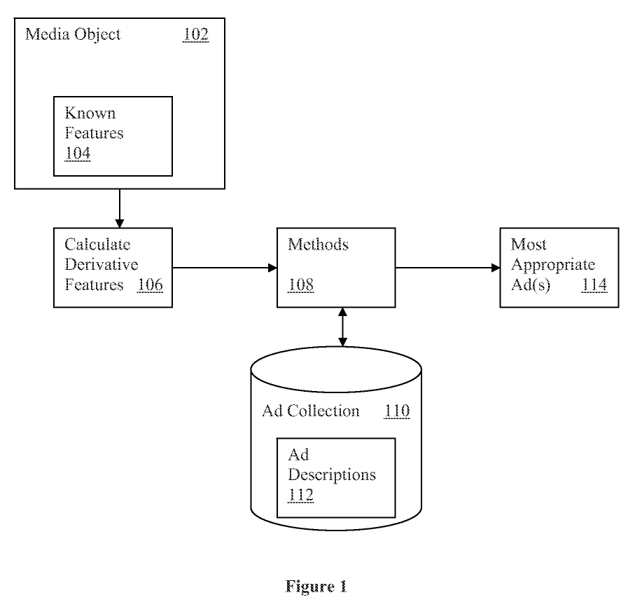

FIG. 1 illustrates an overview of the invention, in accordance with various embodiments. As illustrated, a computing environment (not shown) may read a description of one or more known feature 104 of a media object 102. Logic of the computing environment may then calculate one or more second-order, derivative features 106 (hereinafter, “derivative features 106”) based on the known features 104. In various embodiments, classification or machine learning methods 108 (hereinafter, “methods 108”) of the computing environment may receive the known features 104 and/or the derivative features 106 as parameters, and may evaluate the features 104/106 in light of advertisement features/descriptions 112 (hereinafter, “advertisement descriptions 112”) of a plurality of advertisements of an ad collection 110. In some embodiments, methods 108 may then select one or more advertisements based on the results of the evaluation that may be placed in the media object. The methods 108 may then further determine one or more of the selected advertisements 114 based on advertiser priorities, and may place the determined ad or ads 114 in the media object. In various embodiments, the selections and/or the placements may be based on the received descriptions of the features and/or the derived features of the media objects. Advertisements may be for profit or not for profit; for the purpose of this application, the term may be considered synonymous with “commercial”.

In one embodiment, rather than placing the advertisement 114 into a location within media object 102, the methods 108 may select advertisement(s) to be displayed alongside of media object 102 within a common viewing window, such as a browser. As described above, the advertisement 114 may be placed alongside at a specific instant or topic of the media object 102.

In another embodiment, rather than placing the advertisement 114 into a location within media object 102, the methods 108 may select advertisement(s) to be displayed/placed on another device of the user viewing the media object 102. For example, the advertisement 114 may be rendered on the mobile phone of a user viewing a movie/media object 102 on a computer system. As described above, the advertisement 114 may be placed on the other device at a specific instant or topic of the media object 102.

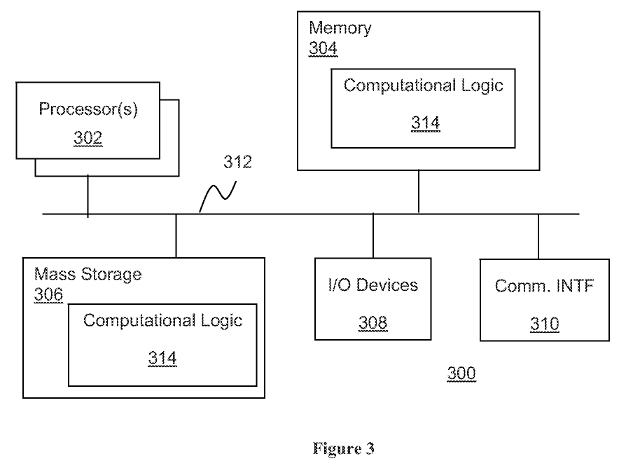

In various embodiments, the computing environment described above may comprise one or more of any single- or multi-processor or processor core central processing unit (CPU) computing system. The computing environment may be or include a personal computer (PC), a workstation, a server, a router, a mainframe, a modular computer within a blade server or high-density server, a personal digital assistant (PDA), an entertainment center, a set-top box, a media player, or a mobile device. Each computing system of the computing environment may be capable of operating a plurality of operating systems (OS) in a plurality of virtual machines using virtualization technologies. An exemplary single-/multi-processor or processor core computing system of the computing environment is illustrated by FIG. 3, and is described in greater detail below. Hereinafter, including in the claims, processor and processor core shall be used interchangeable, with each term including the other.

In embodiments where the computing environment is comprised of two or more computing systems, the computing systems may be connected by a networking fabric and may each include all or portions of at least one of media object 102, known features 104, derivative features 106, methods 108, ad collection 110, advertisement descriptions 112, and the determined ad or ads 114. The networking fabric connecting the computing systems may be any sort of networking fabric known in the art, such as one or more of a local area network (LAN), a wide area network (WAN), and the Internet. The computing systems may further use any communication protocol known in the art, such as the Hypertext Transfer Protocol (HTTP), and any transport protocol known in the art, such as the Transmission Control Protocol/Internet Protocol (TCP/IP) suite of protocols.

As illustrated, a media object 102 may have one or more known features 104. Media object 102 may be any sort of media object known in the art, such as a television program, a film, a radio program, a video game, a song, a banner ad, or any kind of audio, visual, or audiovisual recording. The media object 102 may be available to consumers via a wired or wireless network, or may be transmitted directly to consumers. Additionally, media object 102 may have a duration, and may include multiple topics of interest to consumers. For example, a television show may cover both the topics of recent baseball games and recent fly fishing tournaments. Various instants of the duration and topics from among the multiple topics may comprise or be associated with a location of the media object 102 for the placement of the advertisement(s) 114. Thus, media object 102 may have a plurality of locations where advertisement(s) 114 may be placed. The exact nature of the location(s) may vary based on the type of the media object 102, the instant or topic within the media object 102 associated with/comprising the location, and the type of the advertisement(s) 114. For example, the location might be a space on the side of a car in a television program, film, or video game 102 where a advertiser logo 114 may be placed, or may be an word in a song 102 that may be customized for an advertiser name 114.

In various embodiments, the above-described computing environment may receive media object 102, may only receive a description of known features 104 of the media object (or, in some embodiments, may already have such a description of features 104). In such embodiments, the computing environment may receive the description of features 104 from the same computer system having the media object, or from another computer system. In other embodiments, the computing environment may have the media object 102 stored in local or remote storage of the computing environment.

As is shown, known features 104 may be any sort of description of the content and/or duration of the media object 102. Features 104 may be received by the computing environment from another computer system, either with or without their associated media object 102. Or, in some embodiment, features 104 may be present in the computing environment, and may thus not need to be received. In other embodiments, where the computing environment has the media object 102, logic of the computing environment may derive the features 104 the content of media object 104, such as by a mathematical or computational transformation. For example, a television show 102 may have a descriptive blurb 104 associated with it, such as “Summaries of recent sporting events,” and may include a duration 104, such as twenty-five minutes. In some embodiments, each instant of the duration of a media object 102 may be associated with one or more features 104, such as audio dialogue or narrative of a television show occurring at that instant of the show's duration, or some other word or phrase. Other features may include a word or phrase associated with a topic of a portion of the media object 102. In one embodiment, logic of the computing environment may assign numerical values to features 104 based on the correspondence of the feature to some keyword or words. For example, if feature 104 is a textual summary, feature 104 may be assigned the value “1” if the summary contains a keyword or words, and “0” if it does not. In other embodiments, each feature 104 may be associated with a weight that may be proportional to a number of occurrences of a word appearing in the feature 104 (assuming the feature 104 is at least partially textual).

As is further shown, one or more second-order, derivative features 106 may be calculated from the known features 104. In various embodiments, the derivate features 106 may be generated by a feature calculator of the computing environment, the feature calculator adapted to expand the feature space of the media object. In one embodiment, the feature-calculator may expand the feature space by extracting words or phrases from features 104. The extracted words or phrases may be all nouns or noun phrases, or may represent a subset of words in a feature 104 that correspond to certain keywords used by the feature calculator as criteria. Such derivative features 106 may include keywords, words, strings, or phrases derived from a known feature 104, such as the descriptive blurb mentioned above. Thus, keywords such as “sporting,” “sporting events,” “recent sporting events,” and “recent events” may be calculated from “Summaries of recent sporting events.” Such derivative features 106 may represent more precise descriptions of topics or instants of media object 102, and may thus facilitate better advertisement 114 selection and placement. In some embodiments, the derivative features may be assignable to numerical values and the feature calculator of the computing environment may assign numerical values to derivative features 106 based on the correspondence of a feature 106 to some keyword or words. For example, if derivative feature 106 is a textual summary, derivative feature 106 may be assigned the value “1” if the summary contains a keyword or words, and “0” if it does not. In various embodiments, upon generating the derivative features 106, the feature calculator may pass features 104/106 to one or more classification and machine learning methods 108 of the computing environment as parameters for evaluation by methods 108.

In various embodiments, the one or more classification and machine learning methods 108 may be any sort of classification or machine learning methods known in the art, such as Bayesian classification methods (including, e.g., the naïve Bayes algorithm), for finding the most appropriate advertisement or advertisements 114, where what is “most appropriate” varies from embodiment to embodiment. Upon reading the features 104/106, methods 108 may retrieve a plurality of advertisement descriptions 112 of advertisements of a collection 110 of advertisements. As described below, the descriptions 112 may be stored locally of the computing environment or remotely on another computer system. Once the descriptions 112 have been retrieved, methods 108 may compare the descriptions 112 to the features 104/106 to determine a measure of similarity between each feature 104/106 and each description 112. Such a comparison may involve textual analysis of features 104/106 and descriptions 112 to find matching strings, or in embodiments, where features 104/106 have been numerically valued, methods may compare the values of features 104/106 and descriptions 112 for the presence of a given keyword or words, to determine if both have the keyword or words. Based on the determined measures resulting from the comparisons, the methods 108 may select one or more advertisements having descriptions 112 determined to have the greatest similarity to features 104/106 of a media object 102. In other embodiments, criteria other than similarity may be used to determine advertisements. In some embodiments, a plurality of advertisements 114 may be selected for the same topic or instant of media object 102, and in other embodiments, advertisements 114 may be selected for a plurality of instants or topics within a media object 102. The number of advertisements 114 selected may vary from embodiment to embodiment.

In some embodiments, methods 108 or other logic of the computing environment may then evaluate the selected advertisements to determine which of the selected advertisements to place in the media object 102 based on one or more advertiser priorities of one or more advertisers of the selected plurality of advertisements. For example, one advertiser may prioritize maximizing profits, while another may prioritize minimizing risks. Methods for determining such optimal advertisement(s) may be similar to those discussed for keywords in “Keyword Effectiveness Prediction Method and Apparatus”, U.S. patent application Ser. No. 11/370,679, filed on Mar. 8, 2006, which is fully incorporated herein by this reference. Based on these priorities, the method 108/logic may determine which of the advertisements determined to be similar should be placed on behalf of the advertiser, thus placing advertisements 114 that are not only similar to a location in a media object 102, but are also desired by advertisers to be placed in those locations. Once this subset (or all) of the selected advertisements is determined, methods 108 or logic of the computing environment may place the advertisements 114 in the locations of the media object 102.

As illustrated advertisement collection 110 may, in various embodiments, be a plurality of advertisements having advertisement descriptions 112. In some embodiments, the collection 110 and descriptions 112 may both be stored in a file or database, such as a relational database, of the computing environment. In other embodiments, one or both of the collection 110 and descriptions 112 may be stored on a computer system of a different computing environment. The advertisement collection may include advertisements of any sort known in the art, including banner ads, product placements, logos, names, pictures, audio object, visual objects, and/or audiovisual objects. The collection 110 may include advertisements from a number of advertisers, each advertiser having its own spending criteria, such as minimizing risk, maximizing profit, etc. Such criteria may be associated with the advertisements of the collection 110 and may be part of descriptions 112.

In various embodiments, advertisement descriptions 112 may comprise one or more keywords describing an advertisement of the collection 110, and may even include a keyword or words associated with each instant or topic of the advertisement, if the advertisement has a duration or multiple topics. In one embodiment, a description 112 may include a type for an advertisement of collection 110 or may be a name or marketing slogan of an advertiser for an advertisement that may be that name or slogan, in a stylized or unstylized fashion, in one embodiment including a logo. In various embodiments, descriptions 112 may be derived from advertisements of collection 110 in the same manner as features 104/106 above were derived, or may be derived in any manner known in the art. And as described above, descriptions 112 may be stored with collection 100 in a separate location, and may be stored on the computing environment or on a different computer system. In some embodiments, logic of the computing environment may assign numerical values to descriptions 112 based on the correspondence of a description or part of a description 112 to some keyword or words. For example, if description 112 is a textual summary, description 112 may be assigned the value “1” if the summary contains a keyword or words, and “0” if it does not.

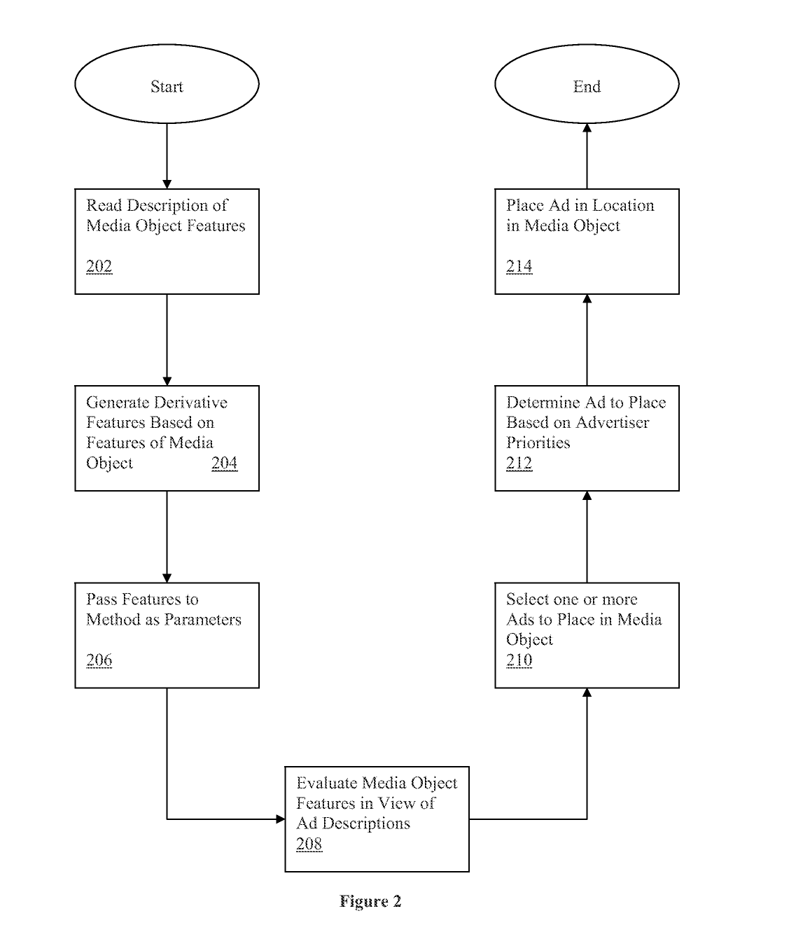

FIG. 2 is a flow chart depicting various embodiments of the invention for placing or selecting advertisements for media objects. As illustrated, a computing environment may read a description of one or more features of a media object, block 202. Such features may comprise at least one of a textual summary of the media object, a duration of the media object, a summary of the media object, a word or description associated with an instant of the duration of the media object, or a word or phrase associated with a topic of at least a portion of the media object. In some embodiments, the media object having the one or more features may be one of a television program, a film, a radio program, a video game, a song, a banner ad, an audio object, a visual object, or an audiovisual object. Upon reading the description, a feature calculator of the computing environment may generate one or more derivative features based on the received features of the media object, block 204. The derivative features may include words, strings, or phrases, and may have numerical or Boolean values indicating their correspondence to one or more keywords. After generating the derivative features, logic of the computing environment may pass the received and/or derivative features as parameters to one or more classification or machine learning methods of the computing environment, block 206. The methods may evaluate received and/or derivative features of the media object in light of descriptions of one or more advertisements, block 208. Such methods may determine measures of similarity between the features and the descriptions. In various embodiments, the advertisements may include banner ads, product placements, logos, pictures, audio objects, visual objects, or audiovisual objects. Upon evaluating the features, the methods may select one or more advertisements to be placed in locations within the media object based on similarity of the descriptions of those advertisements to features of the media object (or based on some other criterion), block 210. In alternate embodiments, the selection may be based only on the received features. In one embodiment, the media object may have multiple locations for advertisement placement which may correspond to an instant of the media object's duration or a topic of the media object. Logic of the computing environment may then further determine which of the selected advertisements should be placed in the locations of the media object based on advertiser priorities, such as maximizing profits or minimizing risks, block 212. Finally, logic of the computing environment may place the determined, selected advertisements in the locations of the media object, block 214.

FIG. 3 illustrates an exemplary computing device capable of performing the operations of various embodiments of the present invention. As shown, computing system/device 300 may include one or more processors 302, and system memory 304. Additionally, computing system/device 300 may include mass storage devices 306 (such as diskette, hard drive, CDROM and so forth), input/output devices 308 (such as keyboard, cursor control and so forth) and communication interfaces 310 (such as network interface cards, modems and so forth). The elements may be coupled to each other via system bus 312, which represents one or more buses. In the case of multiple buses, they may be bridged by one or more bus bridges (not shown).

System memory 304 and mass storage 306 may be employed to store a working copy and a permanent copy of the programming instructions implementing one or more aspects of the above described teachings to practice the present invention, such as computational logic 314. The programming instructions may be implemented in assembler instructions supported by processor(s) 302 or high level languages, such as C, that may be compiled into such instructions.

The permanent copy of the programming instructions may be placed into permanent storage 306 in the factory, or in the field, through e.g. a distribution medium (not shown) or through communication interface 310 (from a distribution server (not shown)).

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A method comprising:
reading, by a computer system, a description describing one or more features of a media object; and
placing, by the computer system, an advertisement into a location within the media object based at least in part on the one or more features of the media object.

2. The method of claim 1, wherein the media object is one of a television program, a film, a radio program, a video games, a song, a banner ad, an audio object, a visual object, or an audiovisual object.

3. The method of claim 1, wherein the one or more features of the media object include at least one of a duration of the media object, a summary of the media object, a word or description associated with an instant of the duration of the media object, or a word or phrase associated with a topic of at least a portion of the media object.

4. The method of claim 1, wherein said placing comprises placing the advertisement into a physical location associated with a rendering of the media object.

5. The method of claim 1, wherein said placing comprises placing, by the computer system, the advertisement into a timing location of a rendering of the media object.

6. The method of claim 1, further comprising generating, by the computer system, one or more derivative features, the derivative features including at least one of a word, a string, or a phrase, for the media object based at least in part on the one or more features of the media object.

7. The method of claim 1, wherein said placing further comprises passing, by the computer system, the one or more feature of the media object as parameters to one or more classification and/or machine learning methods.

8. The method of claim 7, further comprising evaluating, by the one or more classification and/or machine learning methods on the computer system, the one or more features of the media object in view of advertisement descriptions of a plurality of advertisements.

9. The method of claim 7, further comprising selecting, by the one or more classification and/or machine learning methods on the computer system, at least one of a plurality of advertisements for placement in the media object based on one or more advertiser priorities of one or more advertisers of the plurality of advertisements.

10. A method comprising:
reading, by a computer system, a description describing one or more features of a media object;
generating, by the computer system, one or more derivative features including at least one of a word, a string, or a phrase, for the media object based at least in part on the one or more features of the media object; and
selecting, by the computer system, one or more advertisements to be placed in the media object based at least in part on the generated one or more derivative features of the media object.

11. The method of claim 10, wherein the one or more features of the media object include at least one of a duration of the media object, a summary of the media object, a word or description associated with an instant of the duration of the media object, or a word or phrase associated with a topic of at least a portion of the media object.

12. The method of claim 10, wherein the one or more derivative features have numerical values indicating the correspondence of the one or more derivative features to one or more keywords.

13. The method of claim 10, wherein the media object is one of a television program, a film, a radio program, a video games, a song, a banner ad, an audio object, a visual object, or an audiovisual object.

14. An apparatus comprising:
a processor; and
an advertisement placement module operated by the processor and adapted to:
read a description describing one or more features of a media object, and
place an advertisement into a location within the media object based at least in part on the one or more features of the media object.

15. The apparatus of claim 14, wherein the media object is one of a television program, a film, a radio program, a video games, a song, a banner ad, an audio object, a visual object, or an audiovisual object.

16. The apparatus of claim 14, wherein the advertisement placement module is configured to place the advertisement into a physical location of a rendering of the media object.

17. The apparatus of claim 14, wherein the advertisement placement module is configured to place the advertisement into a timing location of a rendering of the media object.

18. The apparatus of claim 14, further comprising an advertisement selection module operated by the processor and adapted to:
read a description describing one or more features of a media object,
generate one or more derivative features for the media object based at least in part on the one or more features of the media object, and
select one or more advertisements to be placed in the media object based at least in part on the generated one or more derivative features of the media object.

19. The apparatus of claim 18, wherein the one or more derivative features include at least one of a word, a string, or a phrase.

20. The apparatus of claim 19, wherein the one or more derivative features have numerical values indicating the correspondence of the one or more derivative features to one or more keywords.
